(19) United States
(12) Patent Application Publication
(10) Pub. No.: US 2023/0039273 A1
(43) Pub. Date: Feb. 9, 2023

(54) EVENT PREDICTION

(71) Applicants: Siemens Canada Limited, Oakville (CA); Siemens Aktiengesellschaft, Munich (DE)

(72) Inventors: Mirjana Zafirovic-Vukotic, Maple (CA); Ermin Sakic, Munich (DE); Johannes Riedl, Landshut (DE)

(21) Appl. No.: 17/758,844

(22) PCT Filed: Feb. 6, 2020
(86) PCT No.: PCT/US2020/016904

§ 371 Date: Jul. 14, 2022

(51) Int. Cl. H04L 41/147; H04L 41/16

(52) U.S. Cl. CPC H04L 41/147; H04L 41/16

(57) ABSTRACT

Examples of techniques for event prediction in a control communication network are disclosed. Aspects include determining state data associated with one or more devices associated with a control communication network, generating, by a machine learning model, a feature vector comprising a plurality of features extracted from the state data, and determining one or more event predictions associated with the control communication network based at least in part on the feature vector.

### BACKGROUND

The present invention relates to electric power control communication networks, and more specifically, to learning machine based event prediction for the management of electric power control communication networks.

An International Electrotechnical Commission (IEC) 61850 system is generally utilized in substation and distribution automation to control and protect power grids such as, for example, SmartGrids, MicroGrids, wind power farms, and the like. In essence, the IEC 61850 is an international standard for defining communication protocols for intelligent electronic devices at electrical substations within the power grids. A substation is a part of an electrical generation, transmission, and distribution system. Substations transform voltage from high to low, or from low to high, or perform any of several other functions. Between the generating station (e.g., power plant) and consumer, electric power may flow through several substations at different voltage levels. A substation may include transformers to change voltage levels between high transmission voltages and lower distribution voltages, or at the interconnection of two different transmission voltages.

Control communication networks that support the above described substations and power generation stations are becoming more and more complex, large, and dynamic with changing conditions and requirements. Because of the complexity of these control communication networks, network operators need automated tools to aid and assist with monitoring and operating these networks.

### SUMMARY

Embodiments of the present invention are directed to a method for event prediction. A non-limiting example of the method includes determining state data associated with one or more devices associated with a control communication network, generating, by a machine learning model, a feature vector comprising a plurality of features extracted from the state data, and determining one or more event predictions associated with the control communication network based at least in part on the feature vector.

Embodiments of the present invention are directed to a system for event prediction. A non-limiting example of the system includes a processor configured to perform determining state data associated with one or more devices associated with a control communication network, generating, by a machine learning model, a feature vector comprising a plurality of features extracted from the state data, and determining one or more event predictions associated with the control communication network based at least in part on the feature vector.

Embodiments of the invention are directed to a computer program product for event prediction, the computer program product comprising a computer readable storage medium having program instructions embodied therewith. The program instructions are executable by a processor to cause the processor to perform a method. A non-limiting example of the method includes determining state data associated with one or more devices associated with a control communication network, generating, by a machine learning model, a feature vector comprising a plurality of features extracted from the state data, and determining one or more event predictions associated with the control communication network based at least in part on the feature vector.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE SEVERAL VIEWS OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a system for a control communication network utilizing event prediction according to one or more embodiments;

FIG. 2 depicts a block diagram of the machine learning system according to one or more embodiments;

FIG. 3 depicts a block diagram of a method for data pre-processing according to one or more embodiments; and

FIG. 4 depicts a block diagram of a computer system for use in implementing one or more embodiments of the present invention.

The diagrams depicted herein are illustrative. There can be many variations to the diagrams or the operations described therein without departing from the spirit of the invention.

### DETAILED DESCRIPTION

Turning now to an overview of technology more relevant to aspects of the present invention, control communication networks that support IEC 61850 systems are becoming more and more complex. As such, network operators require a variety of automated tools to effectively manage these networks. In particular, prediction of events in the control communication network can be of particular interest to a network operator so that the network operator can enact certain actions to account for upcoming, predicted events. A problem exists on how to use state data collected from the control communication network and from real-time control applications to effectively predict events that can affect the control communication network. For example, predicted events can include IEC61850 message transfer delays, losses expected to exceed a threshold, or control network node interface transmit/receive counters expected to exceed pre-defined thresholds. Based on these predictions, an action can be taken including, for example, a modification of the IEC61850 message retransmission mechanism, preventive maintenance, network reconfiguration, network upgrade/change, modification in the background traffic, or other actions which bring value to the network and application operators.

Aspects of the present invention provide for an automated, real-time, event prediction system for the above described control communication networks that, for instance, implement and support IEC 61850 systems and protocols. This automated event predictions system utilizes learning machines (LMs) that collect and analyze state data associated with the control communication network to learn and predict potential events that can affect the network. Once an event is predicted, the system and/or a network operator can take appropriate actions to address. Learning machines (LMs) are computational entities that rely on one or more machine learning (ML) techniques for performing a task for which they have not been explicitly programmed to perform. A machine learning model defines the relationship between features and labels. A feature is an individual measurable property or characteristic of a phenomenon being observed. In this case, a feature can be data related to the operation of various electronic equipment within the network. A label, in machine learning, is a desired output for a given input in a dataset (e.g., a set of features). For example, an image dataset may have a desired output of a label describing the subject of the image in the dataset. ML models include classification and regression models types.

A classification model predicts discrete values. For example, a classification model based on artificial neural networks may have features f1, f2, as its input, and label g as its output, and between these two layers it has a hidden layer with simple rectified linear units (ReLU), and with a weight wi associated with each connections between the artificial neural network nodes belonging to the adjacent layers. A regression model, on the other hand, predicts continuous values. For example, a regression model predicts the value a variable will have at a certain time in the future. A simple model may be g=w0+w1*f1+w2*f2, where the features are f1, f2, the label is g and each feature has its weight wl, w2. Machine learning models typically require training (sometimes referred to as learning). Training the ML model includes showing the machine learning model labeled examples (i.e., features and their associated labels) and enabling the model to gradually learn the relationships between features and one or more labels. A ML model with a simple artificial neural network model is given labeled examples f1, f2, g, and the model will then determine the weight in the hidden layer wi. For a LM with a simple regression model, the model is given labeled examples f1, f2, and g, from which the model will choose w0, w1, w2 for the model equation above. The learning process is done with an objective to minimize the observed errors (i.e., minimize an objective function), e.g., min {Σ(g′−g)/2} with g equal to the value in the labeled examples and g′ equal to the value that results from the model. Prediction, in machine learning, refers to the label g′ that results when a trained model is applied to a feature. So when a trained model is given f1, f2, the model will make a prediction g′. The machine learning model can be modified and tailored to exact example properties. Such modification are the result of monitoring the objective function value, experience, guesses, etc. Such modifications and simplicity of the model can aid in avoiding overlearning, also referred to as overfitting.

In one or more embodiments, the machine learning techniques described above and herein can be utilized to predict events in a control communication network. These control communication networks can utilize a variety of network management protocols such as, for example, Network Configuration Protocol (NETCONF). NETCONF uses Yet Another Next Generation (YANG) modeling language for modeling both configuration data as well as state data (i.e., status information and statistics) of network elements. Specifically, YANG data models pertaining to virtual networks make use of Logical Network Elements (LNE). The YANG models of LNEs are made up of resources and functions allocated to these resources. Examples of LNEs are a virtual switch, a logical router, a Virtual Private Network Routing and Forwarding entity, and a Virtual Switching Instance. A NETCONF client can issue a NETCONF <get> operation to the NETCONF server and this operation gets the response with relevant state data about the network. Also, a NETCONF slave issues an event notification when an event of interest (i.e., meeting the specified criteria) has occurred. An event of interest can include a certain parameter value associated with the network exceeding a threshold. An event notification is sent to subscribing entities using <create-subscription>operations. The notifications can also be replayed on request from the historical data. Any state data communication by the NETCONF slave includes an associated time stamp <eventTime>indicating the time when the state data was generated by its source.

RESTCONF is a hyper text transfer protocol (HTTP) based protocol that enables web-based access from a RESCONF client to the data defined in YANG and provided by a RESTCONF server. RESTCONF operates on the same YANG data as NETCONF. RESTCONF is defined to be used as an alternative to NETCONF. YANG, NETCONF, and RESTCONF are extended to implement a Network Management Datastore. This Network Management Datastore is a conceptual place to store and access information and can be implemented by, for example, using files, a database, flash memory locations, or combinations thereof. A Network Management Datastore includes data that pertain to a specific virtual network by using the LNE YANG and other models. The Network Management Datastore includes a NETCONF client that communicates with the NETCONF slaves, subscribes to the events of interest, and subsequently populates the data in the Network Management Datastore.

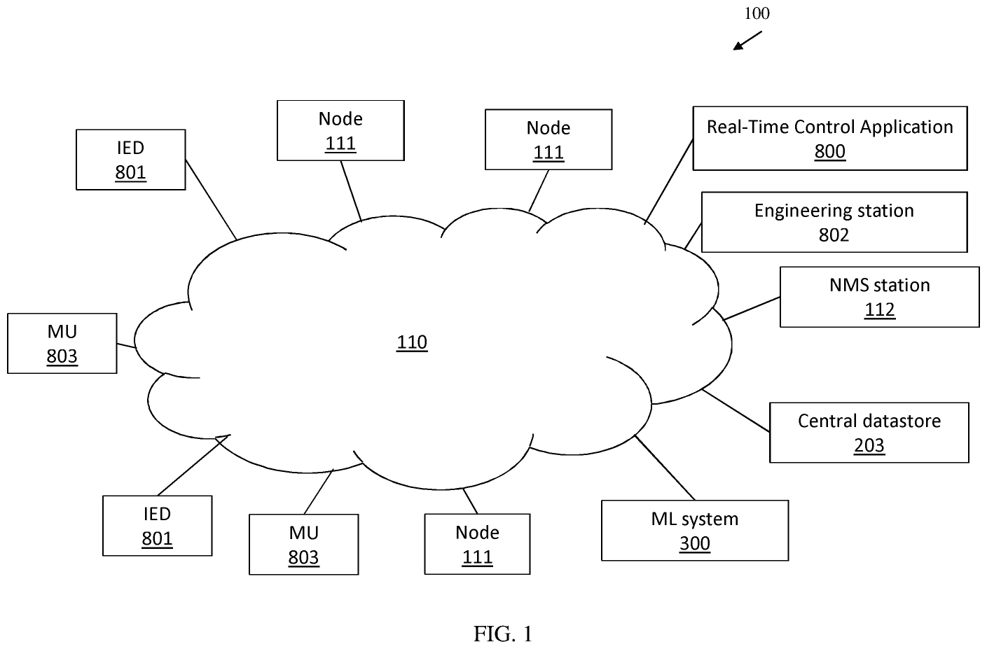

FIG. 1 depicts a block diagram of a system for a control communication network utilizing event prediction according to one or more embodiments. The system 100 includes a real-time control application 800 for managing the control communication network and for predicting events. As mentioned above, IEC61850 systems are generally used in substation and distribution automation to control and protect a power grid. The real-time control application 800 denotes a selected subset of IEC61850 functions with real-time constraints and uses Generic Object-Oriented Substation Event (GOOSE) or Sampled Values (SVs). The real-time control application 800 can encompass the real-time high voltage power grid protection function that has a real-time requirement of 10 ms for a network transfer time. Also, the real-time control application 800 can encompass the power grid telecontrol functions that have a real-time requirement of 40 ms for a network transfer time.

In one or more embodiments, the system 100 includes intelligent electronic devices (IEDs) 801 which are end control devices that can transmit and receive GOOSE messages within the system 100. The system 100 also includes an engineering station 802 that can utilize the real-time control application 800. The engineering station 802 can be considered an IED 801. The IED 801 GOOSE messages can be communicated through a control communication network 110. The GOOSE messages are carrying messages embedded into multicast Ethernet frames that are a response to a poll from the engineering station 802 or the GOOSE messages can be an unsolicited message. The same GOOSE message can be retransmitted with varying and increasing retransmission intervals. Sampled Values (SV) messages carry synchrophasors which are calculated from measured voltage, waveforms, embedded into unicast or multicast Ethernet frames. SV messages are transmitted by merging units (MU), phasor management units (PMU), standalone merging units (SMU), and the like and received by phasor data concentrators (PDC) and the like. The engineering station 802 configures such devices and for simplicity purposes, any device participating in SV message exchanges can be referred to as simply merging units (MUs) 803. The engineering station 802 performs tasks such as, for example, configuring in the IEDs 801, the number of GOOSE retransmissions, the retransmission interval durations, and the collecting and storing of state data for the real-time control application 800.

In one or more embodiments, the control communication network 110 is a virtual network used by the real-time control application 800. This virtual network can run on a physical network and/or on another virtual network or may also be the entire physical network. The physical network may be of type: IEEE 802.3 Ethernet, IEEE Time Sensitive Network (TSN). The control communication network 110 virtual network may be of type: Virtual Local Area Network (VLAN), Virtual Private Network (VPN) based on Internet Protocol (IP) Multiprotocol Label Switching (MPLS), and other. The virtual network type may also be a network slice such as, for example, of the type being specified by European Telecommunications Standards Institute (ETSI) or 3^{rd} Generation Partnership Project (3GPP) for the 5th generation networks and beyond.

In one or more embodiments, the control communication network 110 includes nodes 111. A node 111 is configured for routing and forwarding messages through the network 110. The nodes 111 can be, for example, a virtual switch, a virtual router, and the like. The Ethernet multicast frames carrying GOOSE/SV messages belong to specific multicast groups and are forwarded by the control communication network 110 nodes 111. The real-time control application 800 is configured to communicate through the network 110. In one or more embodiments, the control communication network 110 is a virtual network used by the IEDs 801 and MUs 803. The virtual network allows for the state data collected from the defined network 110 to have a solid quality for further use by the machine learning (ML) system 300.

In one or more embodiments, the system 100 also includes the machine learning (ML) system 300, a network management system (NMS) station 112, the engineering station 802, and a central datastore 203. The ML system 300, NMS station 112, engineering station 802, and central datastore 203 can communicate with each other outside the network 110 through an internal communication method such as, for example, a procedure call.

In one or more embodiments, the control communication network 110 is managed from the NMS station 112 that communicates with the network nodes 111 to perform network management including configuring the nodes 111. Such communication is done outside the control communication network 110 by communication methods such as, for example, IETF Simple Network Management Protocol (SNMP), NETCONF, and the like. NMS station 112 can be implemented in a centralized way, distributed way, or can be virtualized.

In one or more embodiments, the control communication network 110 can be implemented as a Software Defined Network (SDN) comprising an SDN controller, such as, for example, as per IETF RFC7426. The SDN controller can be implemented in a centralized way, distributed way, or can be virtualized. The communication methods can be OpenFlow, dynamic routing protocols like Open Shortest Path First (OSPF) or other. Information exchanged includes dynamic, real-time nodes configuration, state data, notifications and similar from each control network node 111.

In one or more embodiments, the control network nodes 111, the NMS station 112, the central datastore 203, the IEDs 801, the MUs 803, the engineering station 802, and the ML system 300 have their clocks time synchronized to a common clock. For example, such clock synchronization is done by means of IEEE 1588 Time Precision Protocol, or by using Global Navigation Satellite System (GNSS) like General Positioning System (GPS) or by other means. Consequently, any time stamp made by a device is accurate for further use by another devices in the function it performs.

The central datastore 203 is implemented as a Network Management Datastore as described previously above. This central datastore 203 can utilize NETCONF or other methods to collect data and YANG models for virtual networks representation (as described before). The central datastore 203 obtains state data (i.e. status information and statistics) from the control network nodes 111. The central datastore 203 also obtains data from other diverse sources that act as a NETCONF server to the central datastore 203 that acts as a NETCONF client. The central datastore 203 can be a NETCONF slave to the NETCONF client located in the ML system 300. In one or more embodiments, the NMS station 112 includes the central datastore 203. In addition, the real-time control application 800 and the engineering station 802 can include other datastores. These other datastores can utilize an IEC61850 protocol or other methods to collect IEC61850 state data and the corresponding time stamps, e.g. by the methods that the IEC61850 engineering station 802 uses to collects the data from the IEDs 801. The datastore 203 can store data in YANG models and can be a NETCONF slave to a NETCONF client. In some embodiments, these datastores can be the NETCONF slave to a central datastore 203 in which case such central datastore 203 includes information from both the control communication network 110 and from the real-time control application 800, or these datastores can be the NETCONF slave to the client located in the ML system 300 in which case it is also the central datastore 203.

In one or more embodiments, the central datastore 203 can store data specific to the control communication network 110 and to the real-time control application 800. In one or more embodiments, the central datastore 203 can include NETCONF server functionality to a next level client such as the ML system 300 and communicate via an interface. The central datastore 203 contains the current datastore data (i.e., the latest data) and historical datastore data (i.e., the previous data collected over the past time period.) Specifically, the central datastore 203 can include datastore data control network node 111 interface counters that exceed a specified one or more thresholds. The interface counters can count the number of packets transmitted and/or the number of packets received. The datastore date can also include control network node 111 interface status information changes that exceed a specified one or more thresholds and control network node 111 resource utilization that exceeds a specified one or more thresholds. Resource utilization can include link utilization, CPU utilization, RAM utilization, number of multicast groups against the maximum number supported by the switch chip, and the like. In addition, the datastore data can include control network communication quality of service (QoS) parameters that exceed a specified one or more thresholds, the real-time control application 800 GOOSE/SV message transfer delay exceeding a specified one or more thresholds, the real-time control application 800 GOOSE/SV message loss exceeding a specified one or more thresholds, the real-time control application 800 GOOSE/SV message transfer delay exceeding a specified one or more thresholds, and any other measurement data, status information exceeding one or more thresholds pertaining to the control communication network 110 or to the real-time control application 800.

In one or more embodiments, the collection of the above described datastore data does not require notable additional resources like the CPU power from the control network nodes 111 and from the IEDs 801. For example, much of this data can be available through NETCONF with YANG modes. The number of multicast groups against the maximum number supported by the switch chip can be determined by simply retrieving the switch chip information about the used multicast groups and comparing it to the maximum allowable multicast groups as specified by the switch chip manufacturer. The GOOSE/SV message losses can be implemented as a part of the GOOSE/SV transfer function and collected via the IEC61850 protocol and available in the engineering station 802. Further, the control network communication quality of service parameters and the real-time control application GOOSE/SV message transfer delay data leads to high-quality data as inputs for the machine learning system 300. Collection of this data can be implemented within virtualized IEDs 801 and MUs 803 and within the control network nodes 111 by a transmit time stamp inserted into a GOOSE/SV message at the time of its transmission by the IED 801 or MU 803 and the received time stamp is associated with the GOOSE/SV message at the time the message received by the receiving device and at the time the message received at any control network node 111 in the GOOSE/SV message path.

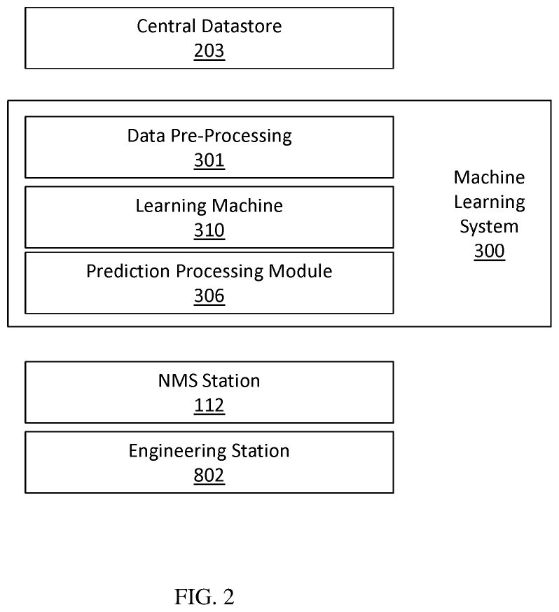

In one or more embodiments, the system 100 utilized the machine learning system 300 to predict an occurrence of one or more events within the control communication network 110. FIG. 2 depicts a block diagram of the machine learning system according to one or more embodiments. The ML system 300 includes a data pre-processing 301 module, a learning machine 310, and a prediction processing 306 module. In one or more embodiments, the learning machine 310 can be implemented using hardware assisted artificial neural network learning and predictions.

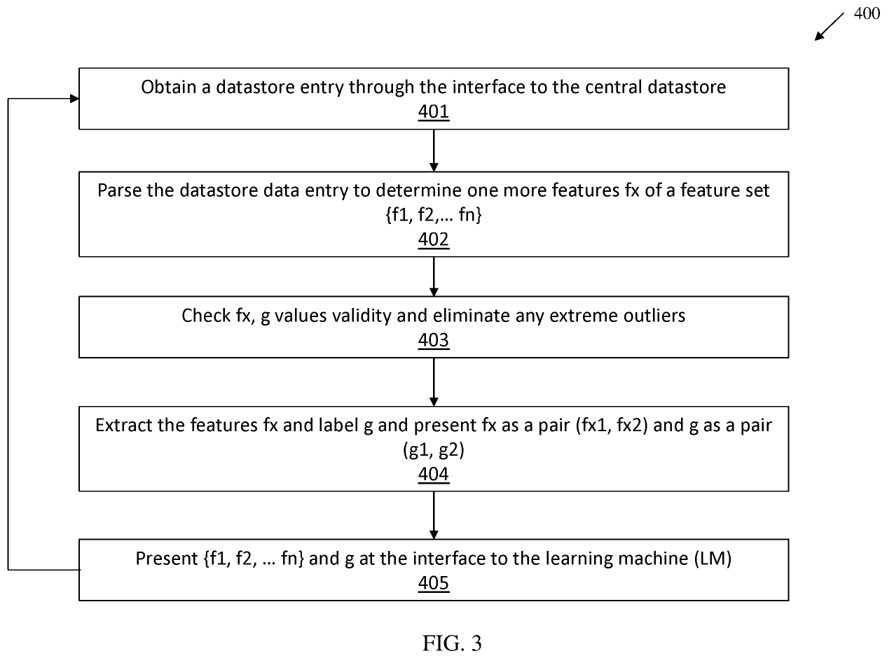

In one or more embodiments, the data pre-processing module 301 can subscribe to the central datastore 203 to obtain the datastore data. The pre-processing module 301 obtains the datastore data through an interface between the central datastore 203 and the data pre-processing module 301. The communication method at the interface can be NETCONF and the data model can be YANG. The data-preprocessing module 301 obtains either the online real-time datastore data or can obtain the historical datastore data utilizing the NETCONF notifications replay function or a similar function. FIG. 3 depicts a block diagram of a method for data pre-processing according to one or more embodiments. The method 400 includes method step 401 where the data pre-processing model 301 obtains a datastore data entry through the interface with the central datastore 203. The method 400 also includes method step 402 wherein the data pre-processing model 301 parses the datastore data entry to determine one or more features fx of a feature set {f1, f2, fn}. The data pre-processing module 301 maps the datastore data into labeled examples {f1, f2, fn, g}, where a labelled example includes features {f1, f2, . . . fn} and the label g. The method 400 includes method step 403 where the data pre-processing module 301 also checks fx and g values and eliminates any extreme outliers using various techniques. The labeled examples {f1, f2, fn, g} corresponds to the datastore data and adhere to specific formats and values where the values can be binned, normalized, and generally belonging to a set or range of assigned values. The method 400 also includes method step 404 where the data pre-processing module 301 extracts features fx and label g and presents fx as a pair (fx1, fx2) and g as a pair (g1, g2). Here, f1x is the feature value and f2x is the corresponding time stamp of the event. For example, for a feature called “real-time control application delay exceeded” instance value may be 0 or 1 corresponding to No or Yes and the time stamp may be 10. The time stamp values are binned to correspond to a time interval equal to a multiple of the power grid measurement sampling interval, for example. The label g is presented as a pair (g1, g2) where g1 is the value and g2 is the time stamp of the event. The method 400, at method step 405, includes the data pre-processing module 301 presenting the features {f1, f2, fn} and g at the interface to the learning machine.

Additional processes may also be included. It should be understood that the processes depicted in FIG. 3 represent illustrations, and that other processes may be added or existing processes may be removed, modified, or rearranged without departing from the scope and spirit of the present disclosure.

In one or more embodiments, the label g in a labeled example {f1, f2, fn, g} can be utilized to train a ML model. The label g′ is a prediction corresponding to the feature {f1, f2, . . . fn}. In the ML system 300, the label g′ has a time stamp in the future and corresponds to the current feature {f1, f2, . . . , fn}. That is to say, the label g′ is an event prediction that will occur at some future time. The same layout applies for label g′ as label g. Thus, the layout of features fx (f1x, f2x ) and the layout of label g/g′ are the same which has the benefit that the pre-processed data presented to the learning machine 310 can more easily be used for diverse multi-class predictions. That is to say, a labeled example {f1, f2, . . . fn, g} can be used by the LM 310 and any corresponding modifications where fx and g have exchanged positions and meanings can be used by another learning machine.

In one or more embodiments, the data pre-processing module 301 can provide labeled examples {f1, f2 . . . fn, g} to the LM 310. This allows for the LM 310 to train a machine learning model using the labeled examples for online learning. The training can also be off-line based on the off-line historical data that the pre-processing model 310 presents as labeled examples from the historical data. This off-line learning can be utilized to either train the initial machine learning model or to update the machine learning model. In one or more embodiments, a previously trained machine learning model can be utilized as an initial machine learning model for the LM 310. This can occur when a change occurs in the network such as a network configuration change, the addition of a new IED 801, and the like.

In one or more embodiments, the machine learning model provides event predictions for the control communication network 110 by generating a prediction label g′ for a set of features {f1, f2 . . . fn}. In one or more embodiments, there can be more than one prediction event (i.e., more than one g′). The machine learning model can be a simple artificial neural network model like a two layers model with a hidden layer in between. This machine learning model can be utilized to predict if a threshold is to be exceeded (e.g., events). For example, if a prediction can include GOOSE/SV message transfer delay exceeding a specified one or more thresholds. The machine learning tools can include learning and prediction methods such as, for example, artificial neural networks and accommodate the specific model learning on the specific data. In addition, the machine learning model can be a regression model that uses the features with actual values and predicts actual values.

In one or more embodiments, the machine learning model predictions g′ can be monitored. This is accomplished by comparing the prediction g′ to the actual values g over time and observing the objective function. Based on these observations, the machine learning model employed can be modified to provide a more desirable prediction outcome (i.e., a better value of the objective function). This can allow for retraining of the model or employing a different model based on the event predictions.

In one or more embodiments, the LM 310 makes predictions g′ available to the predictions processing module 306. The predictions processing module 306 processes predictions g′ from one or more LMs 310. The predictions processing module 306 converts predictions g′ into practical predictions that it presents at a user interface at the NMS station 112, for example. The events predicted in practical predictions can include, for example, IEC61850 message transfer delay expected to exceed one or more thresholds, IED 61850 message loss expected to exceed one or more thresholds, and control network node 111 interface counters expected to exceed one or more thresholds. The interface between the prediction processing module 306 and the NMS station 112 can be implemented as NETCONF, YANG, SNMP, or as another communication type interface utilized by the NMS station 112.

In one or more embodiments, once a practical prediction is made, the NMS station 112 can take one or more actions based on the prediction. For example, the NMS station 112 can send a notification to the IEC61850 engineering station 802, can initiate modifications in the control communication network 110, or take any other action to address the predicted event for the control communication network. The engineering station 802 can make a modification to the control communication network based on the prediction. For example, if the predicted event includes that the number of packets lost will exceed a threshold, the following actions can include, but are not limited to, reconfiguring the IEDs for smaller GOOSE retransmission intervals, reconfiguring the IEDs for more GOOSE retransmissions, initiating preventative maintenance of the IED 801/MU 803, and reconfiguring for smaller polling intervals to the IEDs 801. In addition, the engineering station 802 can issue a warning to a grid operator for further analyses as to the reason the event prediction has occurred and initiate appropriate actions. In one or more embodiments, any of the components described in FIG. 1 can initiate an action including the NMS station 112, real-time control application 800, and the engineering station 802. Such actions can include, for example, the reduction of video monitoring or other traffic that has an adverse effect on the control communication network 110. Other exemplary actions include increasing capacity of the control communication network 110 by adding a virtual link, increasing a virtual link capacity, reconfiguring forwarding pertaining to the virtual network, and any other modifications. Reconfiguring forwarding refers to adjusting a path within the control communication network. The adjusting can include a new path for forwarding and/or adjustments to the current path for forwarding. To initiate a preventative maintenance, an exemplary action can include inspecting and fixing a cable on a failing link or inspecting and fixing a failing switch.

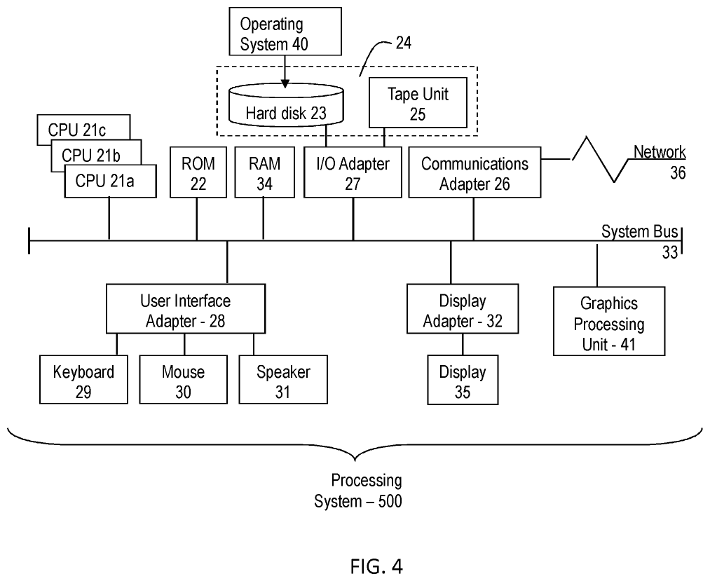

Referring to FIG. 4, there is shown an embodiment of a processing system 500 for implementing the teachings herein. In this embodiment, the system 500 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 500.

FIG. 4 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 500 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 4, the system 500 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 4.

In embodiments of the invention, the machine learning system 300 can also be implemented as a so-called classifier (described in more detail below). In one or more embodiments of the invention, the features of the various machine learning systems 300 described herein can be implemented on the processing system 500 shown in FIG. 4 , or can be implemented on a neural network. In embodiments of the invention, the features of the machine learning system 300 can be implemented by configuring and arranging the processing system 500 to execute machine learning (ML) algorithms. In general, classification ML algorithms, in effect, extract features from received data (e.g., inputs to the machine learning system 300) in order to “classify” the received data. Examples of suitable algorithmic methods include but are not limited to neural networks (described in greater detail below), support vector machines (SVMs), logistic regression, decision trees, hidden Markov Models (HIMMs), etc. The end result of the classifier's operations, i.e., the “classification,” is to predict a class for the data; The end result of regression models is to predict a future value. The ML algorithms apply machine learning techniques to the received data in order to, over time, create/train/update a unique “model.” The learning or training performed by the machine learning system 300 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In embodiments of the invention where the machine learning system 300 are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network. In the descriptions here, any functionality ascribed to the system 100 can be implemented using the processing system 500 applies.

The present invention may be a system, a method, and/or a computer program product at any possible technical detail level of integration. The computer program product may include a computer readable storage medium (or media) having computer readable program instructions thereon for causing a processor to carry out aspects of the present invention.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
determining state data associated with one or more devices associated with a control communication network;
generating, by a machine learning model, a feature vector comprising a plurality of features extracted from the state data; and
determining one or more event predictions associated with the control communication network based at least in part on the feature vector.

2. The method of claim 1, further comprising:
initiating an action for the control communication network based on the one or more event predictions.

3. The method of claim 2, wherein the action comprises reducing video monitoring traffic in the control communication network.

4. The method of claim 2, wherein the action comprises a preventative maintenance action on the control communication network.

5. The method of claim 4, wherein the preventative maintenance action comprises a scheduled inspection of at least one device in the one or more devices associated with the control communication network.

6. The method of claim 2, wherein the one or more event predictions comprises a number of packets lost in the control communication network exceeds a threshold; and
wherein the action comprises at least one of reconfiguring at least one device in the one or more devices to reduce GOOSE retransmission intervals, reconfiguring at least one device in the one or more devices to increase GOOSE retransmissions, initiating a preventative maintenance of at least on device in the one or more devices, and reconfiguring at least one device in the one or more devices to reduce polling intervals to the at least one device.

7. The method of claim 2, wherein the action comprises at least one of adding a virtual link to the control communication network, adding a physical link to the control communication network, and reconfiguring forwarding to utilize a new path or other path associated with the control communication network.

8. The method of claim 1, wherein at least one feature in the plurality of features comprises a time stamp.

9. The method of claim 1, wherein the control communication network comprises an IEC 61850 network protocol.

10. A system comprising:
a memory comprising computer readable instructions; and
a processing device coupled to a memory, the processing device configured to:
determine state data associated with one or more devices associated with a control communication network;
generate, by a machine learning model, a feature vector comprising a plurality of features extracted from the state data; and
determine one or more event predictions associated with the control communication network based at least in part on the feature vector.

11. The system of claim 10, wherein the processing device is further configured to initiate an action for the control communication network based on the one or more event predictions.

12. The system of claim 11, wherein the action comprises reducing video monitoring traffic in the control communication network.

13. The system of claim 11, wherein the action comprises a preventative maintenance action on the control communication network.

14. The system of claim 11, wherein the preventative maintenance action comprises a scheduled inspection of at least one device in the one or more devices associated with the control communication network.

15. The system of claim 11, wherein the one or more event predictions comprises a number of packets lost in the control communication network exceeds a threshold; and
wherein the action comprises at least one of reconfiguring at least one device in the one or more devices to reduce GOOSE retransmission intervals, reconfiguring at least one device in the one or more devices to increase GOOSE retransmissions, initiating a preventative maintenance of at least on device in the one or more devices, and reconfiguring at least one device in the one or more devices to reduce polling intervals to the at least one device.

16. The system of claim 11, wherein the action comprises at least one of adding a virtual link to the control communication network, adding a physical link to the control communication network, and reconfiguring forwarding through a new path associated with the control communication network.

17. A computer program product comprising:
a computer readable storage medium having program instructions embodied therewith, the program instructions executable by a processing device to cause the processing device to perform:
determining state data associated with one or more devices associated with a control communication network;
generating, by a machine learning model, a feature vector comprising a plurality of features extracted from the state data; and
determining one or more event predictions associated with the control communication network based at least in part on the feature vector.

18. The computer program product of claim 17, further comprising:
initiating an action for the network based on the one or more event predictions.

19. The computer program product of claim 18, wherein the action comprises reducing video monitoring traffic in the control communication network.

20. The computer program product of claim 18, wherein the action comprises a preventative maintenance action on the control communication network.
